(19) United States
(12) Patent Application Publication
(10) Pub. No.: US 2008/0253332 A1
(43) Pub. Date: Oct. 16, 2008

(54) SELECTIVELY ACQUIRED SYSTEM INFORMATION

(75) Inventors: Ivan Ore, Nummela (FI); Lars Dalsgaard, Oulu (FI); Sari Nielsen, Espoo (FI); Jarkko T. Koskela, Oulu (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/052,901

(22) Filed: Mar. 21, 2008

Related U.S. Application Data
(60) Provisional application No. 60/896,401, filed on Mar. 22, 2007.

(51) Int. Cl. H04Q 7/00

(52) U.S. Cl. 370/331

(57) ABSTRACT

A method, apparatus and computer program product are provided that improve mobility procedures between base stations based on rules configurable by the operator that govern both the mobile terminal and the base stations. A method is provided in which a mobile terminal obtains system information from a neighboring base station. The system information is stored at the mobile terminal such that the mobile terminal may thereafter participate in a handover or reselection to a respective neighboring base station at least partially based upon the stored system information, typically without further verification of the system information. If desired, the mobile terminal can further determine if one or more predefined validity criterion is met with respect to the stored system information. If the predefined validity criterion is not met, the mobile terminal can then obtain system information, e.g., updated system information, from the neighboring base station.

### CROSS-REFERENCE TO RELATED APPLICATIONS

This application claims priority from U.S. Provisional Application No. 60/896,401, filed Mar. 22, 2007, entitled SELECTIVELY ACQUIRED SYSTEM INFORMATION, the contents of which are incorporated herein by reference.

### FIELD OF THE INVENTION

Embodiments of the present invention relate generally to wireless communication technology and, more particularly, relate to an apparatus, method and a computer program product for facilitating handover by obtaining and storing system information from neighboring cells.

### BACKGROUND OF THE INVENTION

Current and future networking technologies continue to facilitate ease of information transfer and convenience to users. In order to provide easier or faster information transfer and convenience, telecommunication industry service providers are developing improvements to existing networks. For example, the evolved universal mobile telecommunications system (UMTS) terrestrial radio access network (E-UTRAN) is currently being developed. The E-UTRAN, which is also known as Long Term Evolution (LTE) or 3.9G, is aimed at upgrading prior technologies by improving efficiency, lowering costs, improving services, making use of new spectrum opportunities, and providing better integration with other open standards.

One advantage of E-UTRAN which continues to be shared with other preceding telecommunication standards is the fact that users are enabled to access a network employing such standards while remaining mobile. Thus, for example, users having mobile terminals equipped to communicate in accordance with such standards may travel vast distances while maintaining communication with the network. In this regard, it is currently common for an access point or base station providing network coverage for a particular area (or cell), to pass off communication with a particular mobile terminal to a neighboring base station when the user of the particular mobile terminal exits the coverage area of the base station or can otherwise be more effectively served by the neighboring base station. This process is often referred to as a handover.

Despite the evolution and improvement of telecommunication networks, the process of handover may sometimes consume more power from the mobile terminal than is desired and/or may not be performed in the most efficient manner. In this regard, one technique for effectuating a handover process would be to permit a mobile terminal to obtain system information from the neighboring cells. Among other things, this system information would provide information regarding the availability of the neighboring base stations. In some instances, for example, the neighboring base stations may be barred and therefore unavailable as a handover candidate since the neighboring base stations may be dedicated to a private network. Additionally, the system information may identify the network with which the neighboring base station is affiliated so that it may be determined if the neighboring base station is in the home network of the mobile terminal or in a visited network to which the mobile terminal may roam.

Although the system information may be obtained from neighboring base stations in a variety of manners, one technique that has been employed by the UMTS terrestrial radio access network (UTRAN) gathers system information differently depending upon whether the mobile terminal is in the idle mode or the dedicated mode. Among other things, the techniques employed in UTRAN in both the idle and dedicated modes provide some limits upon the instances in which the mobile terminal is required to read the system information broadcast by the neighboring base stations in order to limit the power of the mobile terminal that is consumed in the course of reading the system information. In this regard, the battery power available to a mobile terminal is generally limited such that limitations upon the power consumed by the mobile terminal are generally advantageous.

In the idle mode, the base station that is currently serving the mobile terminal may assist the mobile terminal in selecting a neighboring base station to which the mobile terminal is to be handed over. In this regard, the serving base station may provide the mobile terminal with a list of neighboring base stations along with various parameters used in a cell reselection algorithm executed by the mobile terminal. The mobile terminal may then measure and evaluate the cell reselection algorithm based upon information received from the serving base station. Prior to the reselection, the mobile terminal then reads at least some of the system information that is broadcast by the selected neighboring base station, such as via a broadcast channel (BCCH) in UTRAN, in order to prepare for the reselection process. In instances in which reselection occurs numerous times, however, the mobile terminal may still be required to repeatedly read the system information, thereby consuming more power than is desired. For example, a mobile terminal may be located in an overlapping area between two base stations so that the cell supporting the mobile terminal is repeatedly reselected so as to change from one cell to the other cell and then back again. In this instance, the mobile terminal will repeatedly be required to read the system information broadcast by the neighboring base station prior to a reselection which may occur many times in an hour, for example.

In contrast, in a dedicated mode in UTRAN, the mobile terminal is not required to read the system information of any of the neighboring base stations with the responsibility for identifying the neighboring base stations being delegated, instead, to the network serving the mobile terminal. While reliance upon the network to identify and communicate with the neighboring base station limits the power consumption of the mobile terminal, this reliance upon the network disadvantageously limits the mobility procedures in the network. For example, since the mobile terminal is not aware of the system information relating to the neighboring base stations, the mobile terminal may unnecessarily transmit measurement reports from the neighboring cells to the serving base station for at least some neighboring cells that may have access restrictions, such as banned cells that are dedicated to private networks or the like, and that do not present realistic handover options, thereby unnecessarily and undesirably increasing the signaling load between the mobile terminal and the serving base station. Additionally, a mobile terminal that is roaming and is unaware of the system information of the neighboring base stations will be unable to identify a neighboring base station that belongs to the home network of the mobile terminal and, as such, the handover of the mobile terminal to the neighboring base station that belongs to the home network of the mobile terminal may be disadvantageously delayed. Further, a mobile terminal that is unaware of the system information of the neighboring base station may be unable or less able to support network self-configuration and self-optimization procedures. In contrast to UTRAN, in a dedicated mode in GSM EDGE Radio Access Network (GERAN), the mobile terminal may read the system information, but the operator is unable to define how and how long the mobile terminal will retain the system information.

Accordingly, despite continued efforts to improve telecommunications capabilities, there may be an existing need to improve mobility procedures, in the idle and/or dedicated modes, by providing the mobile terminal with the requisite system information for the neighboring base stations in a manner that permits more efficient power consumption by the mobile terminal.

### BRIEF SUMMARY OF THE INVENTION

A method, apparatus and computer program product are therefore provided that improves handover or reselection between base stations (which in E-UTRAN are referred to as node-Bs). In one embodiment, a method for facilitating handover or reselection is provided in which a mobile terminal obtains at least some system information from at least one neighboring base station. According to this embodiment, the system information is stored at the mobile terminal such that the mobile terminal may thereafter participate in a handover or reselection to a respective neighboring base station at least partially based upon the stored system information associated with the respective neighboring base station. As such, the mobile terminal may participate in the handover or reselection based upon the stored system information without further verification of the system information. In one embodiment, the mobile terminal further determines if one or more predefined validity criterion, such as a validity criterion defined by rules that are configured by the operator and established between the mobile terminal and the network, is met with respect to the stored system information. If the predefined validity criterion is not met for the system information associated with a neighboring base station, the mobile terminal can then obtain system information, e.g., updated system information, from the neighboring base station. Accordingly, the benefits associated with the mobile terminal being aware of the system information associated with the neighboring base stations can be enjoyed while concurrently reducing, in many instances, the number of times that the mobile terminal must read system information broadcast by the neighboring base stations so as to conserve the limited power available to the mobile terminal.

In another exemplary embodiment, a computer program product for facilitating handover or reselection is provided. The computer program product may include at least one computer-readable storage medium, such as a memory device of a mobile terminal, having computer-readable program code portions stored therein. The computer-readable program code portions may include a first executable portion, a second executable portion and a third executable portion. The first executable portion may be for obtaining at least some system information from at least one neighboring base station. The second executable portion may be for storing the system information at the mobile terminal, while the third executable portion may be for participating in a handover or reselection to a respective neighboring base station at least partially based upon the stored system information associated with the respective neighboring base station, typically without further verification of the system information. In one embodiment, the computer-readable program code portions further include a fourth executable portion that may be for determining if one or more predefined validity criterion, such as a validity criterion defined by rules that are configured by the operator and established between the mobile terminal and the network, is met with respect to the stored system information and, if not, may cause the first executable portion to obtain system information, e.g., updated system information, from the neighboring base station.

In another exemplary embodiment, an apparatus for facilitating handover or reselection is provided. The apparatus may include a processing element configured to obtain at least some system information from at least one neighboring base station. The processing element is also configured to store the system information at the mobile terminal and to then participate in a handover or reselection to a respective neighboring base station at least partially based upon the stored system information associated with the respective neighboring base station, typically without further verification of the system information. In an exemplary embodiment, the processing element may be further configured to determine if one or more predefined validity criterion, such as a validity criterion defined by rules that are configured by the operator and established between the mobile terminal and the network, is met with respect to the stored system information and, if not, to obtain system information, e.g., updated system information, from the neighboring base station.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a schematic diagram showing a portion of an E-UTRAN according to an exemplary embodiment of the present invention;

FIG. 4 is a schematic diagram illustrating a signal sequence re-use distance;

FIG. 5 is a flowchart according to an exemplary method of obtaining and storing system information from a plurality of neighboring base stations according to an exemplary embodiment of the present invention; and

FIG. 6 is a flowchart according to an exemplary method of facilitating handover according to an exemplary embodiment of the present invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

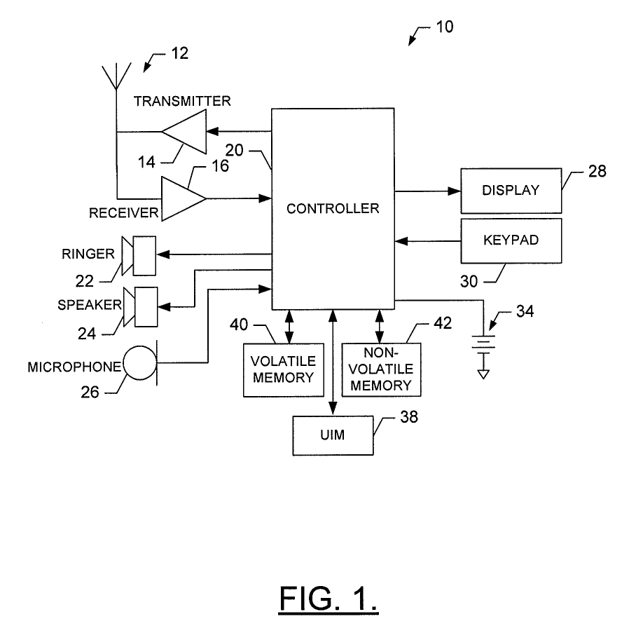

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, LTE or E-UTRAN, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

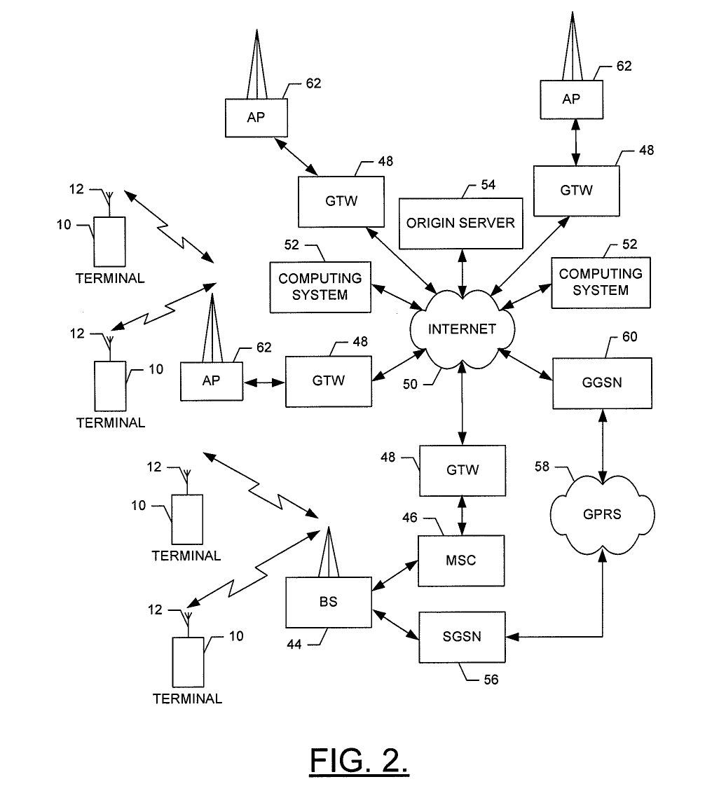

Referring now to FIG. 2, a schematic block diagram of one type of wireless communications system that would benefit from embodiments of the present invention is provided. The system includes a plurality of network devices. As shown, one or more mobile terminals 10 may each include an antenna 12 for transmitting signals to and for receiving signals from a base site or base station (BS) 44. While a BS may be comprised of one or more cells, reference herein to a BS generically refers to both a BS and a cell of the BS. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as E-UTRAN or a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile terminals (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), WifAX techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1 and a network device of the system of FIG. 2 in order to execute applications for establishing communication between the mobile terminal 10 and other mobile terminals, for example, via the system of FIG. 2. As such, it should be understood that the system of FIG. 2 need not be employed for communication between mobile terminals or between a network device and the mobile terminal, but rather FIG. 2 is merely provided for purposes of example.

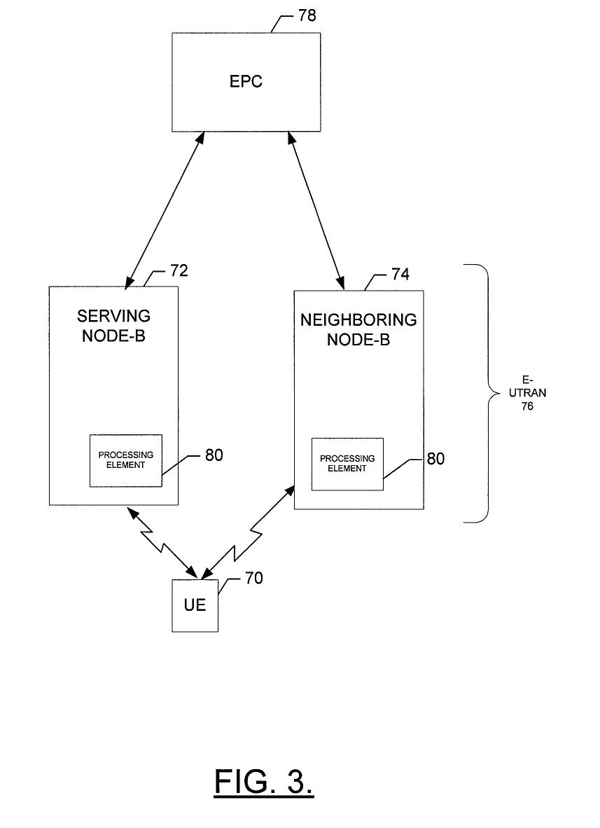

An exemplary embodiment of the invention will now be described with reference to FIG. 3, in which certain elements of a system for facilitating handover or reselection are presented. In this regard, it is noted that while handover occurs in the dedicated mode and reselection occurs in the idle mode, the terms “handover” and “reselection” may be used interchangeably herein to describe either or both handover and reselection processes as embodiments of the present invention may apply in both the idle and dedicated modes. The system of FIG. 3 represents a specific embodiment of a network such as the general network displayed in FIG. 2, except that FIG. 3 represents a general block diagram of an E-UTRAN. As such, in connection with FIG. 3, user equipment (UE) 70 may be exemplary of one embodiment of the mobile terminal 10 of FIG. 1 and source node-B 72 and target node-B 74 may be exemplary of embodiments of either the BS 44 or AP 62 of FIG. 2. However, it should be noted that the system of FIG. 3, may also be employed in connection with a variety of other devices, both mobile and fixed, and therefore, embodiments of the present invention should not be limited to application on devices such as the mobile terminal 10 of FIG. 1 or the network devices of FIG. 2.

Referring now to FIG. 3, the system includes an E-UTRAN 76 which may include, among other things, a plurality of node-Bs in communication with an evolved packet core (EPC) 78 which may include one or more mobility management entities (MMEs) and one or more system architecture evolution (SAE) gateways. The node-Bs (including source node-B 72 and target node-B 74) may be evolved node-Bs (e.g., eNBs) and may also be in communication with the UE 70 and other UEs.

The node-Bs may provide E-UTRA user plane and control plane (radio resource control (RRC)) protocol terminations for the UE 70. The node-Bs may provide functionality hosting for such functions as radio resource management, radio bearer control, radio admission control, connection mobility control, dynamic allocation of resources to UEs in both uplink and downlink, selection of an MME at UE attachment, IP header compression and encryption, scheduling of paging and broadcast information, routing of data, measurement and measurement reporting for configuration mobility, and the like.

The MME may host functions such as distribution of messages to respective node-Bs, security control, idle state mobility control, SAE bearer control, ciphering and integrity protection of NAS signaling, and the like. The SAE gateway may host functions such as termination and switching of certain packets for paging and support of UE mobility. In an exemplary embodiment, the EPC 78 may provide connection to a network such as the Internet.

As shown in FIG. 3, the node-Bs may each include a processing element 80 configured to execute functions associated with each corresponding node-B. Such functions could be, for example, associated with stored instructions which when executed by the processing element 80 carry out the corresponding functions associated with the instructions. A processing element such as those described above may be embodied in many ways. For example, the processing element 80 may be embodied as a processor, a coprocessor, a controller or various other processing means or devices including integrated circuits such as, for example, an ASIC (application specific integrated circuit).

In a wireless communication system, such as of the type depicted generally in FIG. 2 and more specifically in FIG. 3, the base stations 44 may broadcast system information, such as via the downlink shared channel (DL-SCH) or the BCCH. In an E-UTRAN, for example, the base stations 72, 74 may broadcast system information in various scheduling units (SU), such as SU-1, SU-2, etc. (hereinafter generically referenced as SU-X). SU-1 is generally the most frequently broadcast scheduling unit and may include the identity of one or more public land mobile networks (PLMN), a tracking area code, a cell identity, a cell barring status, scheduling information of the other scheduling units, i.e., scheduling units other than the SU-1, and system information block (SIB) mapping information, i.e., an indication as to which scheduling units include which SIBs. In this regard, a SU as used herein may simply be an SIB. As will be noted, the system information included in the SU-1 includes, among other things, availability information including access restrictions and access privileges, such as information indicating which cells are barred or restricted, such as by being dedicated to a private network, as well as information relating to the PLMN identities that permit base stations associated with the home network of a mobile terminal 10 to be distinguished from base stations associated with visited networks. In addition to broadcasting the system information, such as that provided via the scheduling units, base stations also broadcast a reference signal sequence and other fundamental information, typically via the packet broadcast channel (P-BCCH), that permit the base stations to be identified by the mobile terminals.

In operation, a mobile terminal 10 reads at least some of the information broadcast by the neighboring base stations 44. In this regard, a neighboring base station is generally considered a base station whose broadcast is detected by the mobile terminal regardless of whether or not the base station is included in a neighboring cell list. By way of example, the mobile terminal initially reads the reference signal sequence and/or other information broadcast by the base stations that identify the respective base stations. In an embodiment employing a mobile terminal of the type depicted in FIG. 1, for example, the controller 20 generally directs the receiver 16 to receive the information broadcast by the neighboring base stations. Based upon the identity of a base station, the mobile terminal and, more typically, the controller of the mobile terminal determines if the system information of the base station should be read. In this regard, if the mobile terminal determines that the system information of the base station has not previously been read and stored by the mobile terminal or, even if previously read and stored, is no longer valid, the mobile terminal may read additional system information broadcast by the base station. In one embodiment, the mobile terminal also insures that the base station is a viable reselection candidate for which predefined cell reselection criteria are met prior to reading the additional system information to avoid expending the resources to read information that proves to be of no value.

In this regard, the mobile terminal 10 reads at least a portion of the system information, such as the system information included in SU-1, broadcast by the neighboring base station 44 that has been identified by the mobile terminal. The mobile terminal then stores at least a portion of the system information that has been broadcast by the neighboring base station and read by the mobile terminal. For example, in an embodiment employing a mobile terminal of the type depicted in FIG. 1, the controller 20 generally directs the receiver 16 to receive the system information broadcast by the neighboring base station and thereafter stores at least a portion, if not all, of the system information in memory, such as volatile memory 40. In this regard, the mobile terminal generally stores the system information in such a way that the system information remains associated with the respective base station, such as by storing not only the system information but also an identification of the respective base station. In one embodiment, the mobile terminal is further configured to compress at least some of the system information that is stored in order to conserve memory based upon, for example, information, such as the tracking area (TA), PLMN, etc., that is common to a plurality of neighboring base stations.

According to embodiments of the present invention, in instances in which the mobile terminal 10 identifies a broadcast by a neighboring base station 44 for which the mobile terminal already has system information stored in memory 40, the mobile terminal need not read the system information of the neighboring base station, but can, instead, generally continue to utilize the stored system information, subject to the further consideration of predefined validity criteria in at least some embodiments as described below. In particular, in response to a broadcast by a neighboring base station that is received by the receiver 16 of the mobile terminal, the controller 20 determines an identity of the neighboring base station and then determines if system information for a base station having the same identity has already been stored in memory. If so, the controller does not read the system information broadcast by the neighboring base station. If, however, the controller determines that the system information associated with the neighboring base station has not been previously stored in memory (or, even if previously stored in memory, is no longer valid), the controller directs the receiver to read the system information for the neighboring base station and then stores the system information of the neighboring base station along with an identification of the respective base station in memory.

In instances, such as shown in the embodiment of FIG. 3, in which a serving base station 72 determines that the mobile terminal, e.g., user equipment 70, while in a dedicated mode should be handed over to a neighboring base station 74, the serving base station can advise the mobile terminal of the upcoming handover including the identity of the neighboring base station to which the mobile terminal is being handed over. The controller 20 of the mobile terminal then determines if system information for the neighboring base station to which the mobile terminal is being handed over is stored in memory 40 (and is still valid as described below in conjunction with some embodiments). If so, the mobile terminal utilizes the system information for the neighboring base station that has been stored in memory to prepare for and to effectuate the handover process including subsequent communications with the neighboring base station. As such, in instances in which the system information for the neighboring base station to which the mobile terminal is to be handed over is stored in memory (and, in one embodiment, is also determined to be valid), the mobile terminal need not read the system information broadcast by the neighboring base station in order to verify the system information prior to handover, but instead relies upon the previously stored system information. In contrast, if the controller determines that the system information for the neighboring base station to which the mobile terminal is to be handed over has not been previously stored in memory (or, in one embodiment, is no longer valid even if the system information has been previously stored in memory), the controller does direct the receiver 16 to read the system information broadcast by the neighboring base station in order to obtain and verify the system information of the neighboring base station in order to prepare for and effectuate the handover.

By relying upon the stored system information to effectuate a handover instead of reading the system information broadcast by the neighboring base station 44 following notification of the handover process, the power consumption of the mobile terminal 10 may be reduced and the signaling load of the mobile terminal may be similarly reduced in certain circumstances. For example, it has been estimated that at least 60% of the users of mobile terminals access the network while remaining stationary during the communication session. Additionally, the number of mobile terminals that operate in a stationary or semi-stationary fashion is expected to increase as applications supporting the use of mobile terminals in indoor scenarios increase and as the number of Internet accessible table-supported devices and the number of other static devices utilizing cellular communication, such as, point-of-sale (POS) devices, increase. In these situations, a mobile terminal will typically be surrounded by and in communication with only a few base stations that remain largely the same over time. By storing and re-using the system information for the neighboring base stations, the number of instances that the mobile terminal must read the system information of the neighboring base stations may generally be reduced relative to conventional approaches, such as conventional approaches in which the system information is read for verification purposes prior to each handover.

In one example, consider a mobile terminal, e.g., user equipment 70, in the idle mode that is utilized by a user to access services through an E-UTRAN as shown, for example, in FIG. 3 from his/her desk. In instances in which the mobile terminal at the user's desk is located in an overlapping area of coverage between base stations 72, 74, ping-pong problems may be unavoidable. Conventionally, the system information would be read by the mobile terminal prior to each reselection of the mobile terminal from one base station to the other base station while in the idle mode. Since this reselection could occur many times during a day where the mobile terminal is handed back and forth between the same two overlapping base stations, the system information for the base station would have to be repeatedly read by the mobile terminal. In accordance with an embodiment to the present invention, however, the system information, such as the SU-1 information in E-UTRAN, is read by the mobile terminal for each base station and is stored in the memory of the mobile terminal. The mobile terminal can then obtain the system information from memory prior to each handover, thereby re-using the same system information to effectuate the handover processes between the two base stations without having to again read the system information from either base station.

In another application, a user of a mobile terminal, e.g., user equipment 70, in the idle mode may be somewhat mobile, but the mobility may be restricted to a predefined area during a certain time, such as within a home, within a commercial center, an office building or the like. In this instance, a mobile terminal may move through only a small number of different cells, such as the cells supported by four different base stations. As described above, conventional approaches may require the mobile terminal to read the system information prior to each reselection process, thereby requiring the system information to be read a number of times. In contrast, an embodiment of the present invention permits the mobile terminal to read the system information, such as that included in the SU-1 in E-UTRAN, for each of the four base stations and to store the system information. The mobile terminal can thereafter rely upon the stored system information during subsequent reselection processes without again reading the system information. For purposes of example, in instances in which the mobile terminal is subjected to 60 reselections between four base stations in an hour, conventional approaches requiring a mobile terminal to read the system information prior to each reselection would require that the system information be read 60 times per hour, while a mobile terminal according to an embodiment of the present invention would only require the mobile terminal to read the system information on four occasions, i.e., once for each base station, since the same system information can be re-used during subsequent reselection processes.

In order to avoid stale or outdated system information being utilized to support subsequent handover processes, the mobile terminal 10 and, in particular, the controller 20 of the mobile terminal of one embodiment of the present invention may be configured to evaluate the system information for a respective base station 44 in accordance with a predefined validity criteria and to only utilize the stored system information if the stored system information meets or satisfies the predefined validity criteria. In instances in which the stored system information does not meet the predefined validity criteria, the system information for the respective neighboring cell would be read again by the mobile terminal and stored by the mobile terminal in memory 40, thereby effectively updating the system information for the respective base station.

The mobile terminal 10 can determine if the stored system information satisfies the predefined validity criteria at one or more steps of the overall process. For example, in response to receiving information, such as a reference signal sequence, broadcast by and identifying a neighboring base station 44, the mobile terminal can determine if system information for the respective base station is already stored in memory as described above. If the mobile terminal does determine that the system information is already stored in memory for the respective base station, the mobile terminal can then determine if the stored system information satisfies the predefined validity criteria. If the stored system information satisfies the predefined validity criteria, the mobile terminal need not read the system information for the respective base station. However, if the stored system information fails to satisfy the predefined validity criteria, the mobile terminal will again read and store the system information for the respective base station.

Additionally or alternatively, the mobile terminal 10 can determine if the stored system information satisfies the predefined validity criteria following a decision to handover the mobile terminal to a neighboring base station 44. In this regard, the mobile terminal can determine if system information for the respective base station is already stored in memory as described above. If the mobile terminal does determine that the system information is already stored in memory for the respective base station, the mobile terminal can then determine if the stored system information satisfies the predefined validity criteria. If the stored system information satisfies the predefined validity criteria, the mobile terminal need not read the system information for the respective base station and can, instead, utilize the stored system information to effectuate the handover or reselection. However, if the stored system information fails to satisfy the predefined validity criteria, the mobile terminal will again read and store the system information for the respective base station prior to handover or reselection.

A variety of different predefined validity criteria can be utilized. Typically, the predefined validity criteria as well as the other rules governing the manner in which the mobile terminal reads and utilizes/stores the system information that have been described above are defined or configured by the operator and imposed upon or otherwise established between both the mobile terminal 10 and the network such that one aspect of the present invention relates to the network-side or operator configuration of the rules and other criteria and another aspect of the present invention relates to the utilization of those rules and other criteria by the mobile terminal. For example, the predefined validity criteria may be a maximum time that has elapsed since the stored system information was read by the mobile terminal 10 or stored by the mobile terminal. As such, stored system information that is old, i.e., was read by the mobile terminal or stored by the mobile terminal more than the maximum time ago, will not be used and will be required to be re-read by the mobile terminal. Alternatively, the predefined validity criteria can be a maximum number of handovers or reselections of the mobile terminal that have occurred since the reading or storage of the system information by the mobile terminal. As such, if the mobile terminal has been handed over more than a predefined maximum number of times since the system information has been read by or stored by the mobile terminal, the stored system information will not be used and, instead, the mobile terminal will be required to again read the system information for the respective neighboring base station. While two examples of predefined validity criteria are provided, a wide variety of other predefined validity criteria may be utilized including combinations of the foregoing examples of predefined validity criteria.

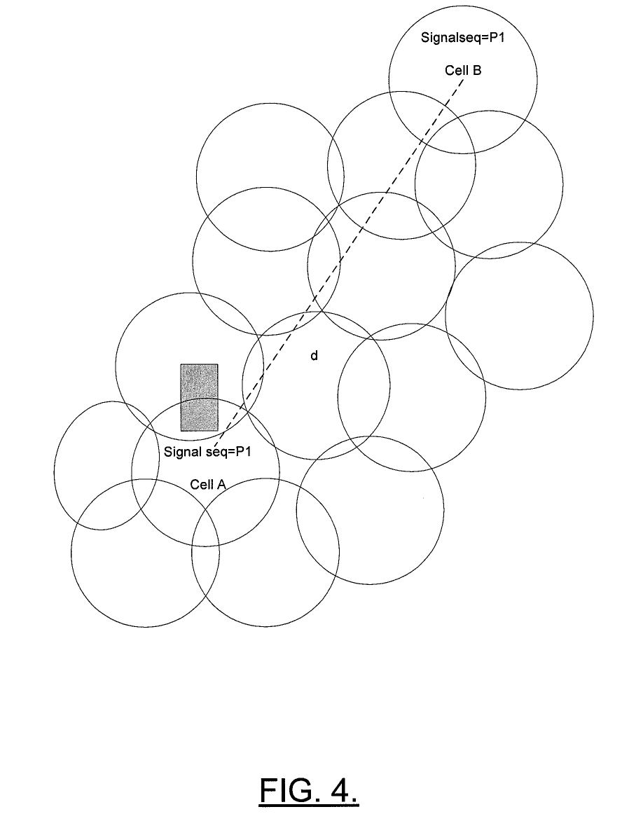

While the neighboring base stations may be identified in various manners as described above, the methods, apparatus and computer program products of embodiments of the present invention advantageously identify the base stations in a unique fashion so as to avoid confusion between two base stations 44 that are identified in a common manner. In this regard, mobile terminal 10 of embodiments of the present invention may utilize the reference signal sequence of a base station 44 to identify the base station. In one example, there are 512 unique reference signals sequences capable of identifying 512 base stations in E-UTRAN. While reliance upon the reference signal sequence and its capacity to uniquely identify 512 base stations is typically acceptable, there may be instances in which two or more base stations are identified by a common reference signal sequence, such as shown in FIG. 4 in which the base stations defining both Cell A and Cell B are defined by the same reference signal sequence designated P1. In this instance, the mobile terminal may identify the base stations by other forms of identification or various combinations of identifiers in order to ensure or at least increase the likelihood of uniquely identifying each base station for which the mobile terminal stores system information.

In this regard, the methods, apparatus and computer program products of embodiments of the present invention may also take into account the signal sequence re-use distance designated d in FIG. 4 such that the stored system information is updated in instances in which the mobile terminal 10 has traveled a distance approaching or approximating the re-use distance since originally storing the system information. In this regard, a proxy for the distance by which the mobile terminal has moved and, in turn, its comparison to the signal sequence re-use distance may be provided by the predefined validity criteria, such as a maximum time and/or a maximum number of handovers, that must be satisfied or else the mobile terminal will be required to read and again store updated system information. For example, a smaller value for the maximum time and a smaller number for the maximum number of handovers generally provide more security that the mobile terminal will not have traveled the signal sequence re-use distance so as encounter another base station that utilizes the same reference signal sequence as a base station for which system information has previously been stored by the mobile terminal.

The various parameters that may be utilized for the predefined validity criteria may therefore be established by an operator based upon a variety of factors including the network topology, anticipated mobility of the mobile terminal, signal sequence re-use distance, anticipated usage of the mobile terminal outdoors or indoors, etc. For example, in instances in which the mobile terminal 10 is anticipated to be utilized in a rural area and to experience relatively low mobility, such as by generally being utilized indoors, the maximum time and/or the maximum number of handovers may be set to relatively larger values. In another example, in instances in which the mobile terminal is expected to be utilized in an area having relatively small signal sequence re-use distances, the maximum time and/or the maximum number of handovers is generally set to a smaller value to avoid or at least reduce the possibility of confusion between base stations having the same radio signal sequence. Still further, in instances in which the mobile terminal is expected to be utilized in environments that may have relatively high interference or high pollutions levels, the operator may disable the capability of the mobile terminal to store and re-use system information and may, instead, utilize a more conventional approach, such as those described above.

In addition to conserving the power available to the mobile terminal 10, the methods, apparatus and computer program products of embodiments of the present invention may also advantageously reduce the data interruption times for the serving base station when the neighboring base stations are not intra-frequency neighboring base stations and the mobile terminal needs to have a discontinuous transmission (DTX)/discontinuous reception (DRX) idle period for reading the scheduling information, such as the SU-1, of the neighboring base station. Additionally, the methods, apparatus and computer program products of embodiments of the present invention may advantageously reduce the signaling load between the mobile terminal and the serving base station since the mobile terminal and, in particular, the controller 20 of the mobile terminal may be configured to not report the scheduling information associated with neighboring base stations that the mobile terminal has read, but that are unavailable for handover purposes, such as banned cells. Further, the methods, apparatus and computer program products of embodiments of the present invention may increase the success rate during handover or redirection since the accessibility or availability of the neighboring base station to which the mobile terminal is being handed over is known prior to the handover or redirection. Still further, the methods, apparatus and computer program product of embodiments of the present invention may improve mobility as the mobile terminal may be able to more quickly identify neighboring base stations that are included in the home network of the mobile terminal and facilitate a more rapid handover to the base station of the home network in instances in which the mobile terminal is otherwise roaming.

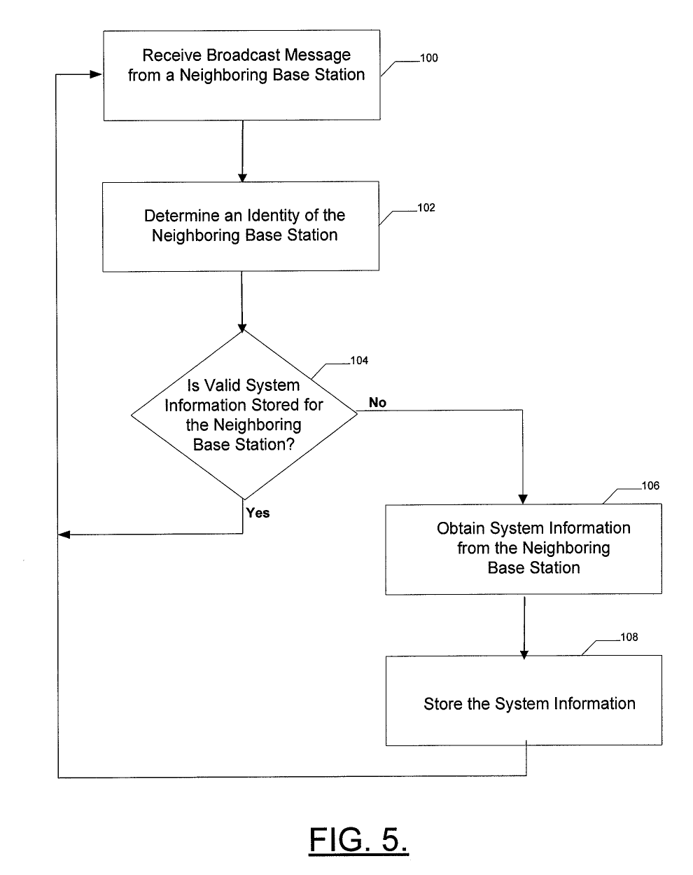

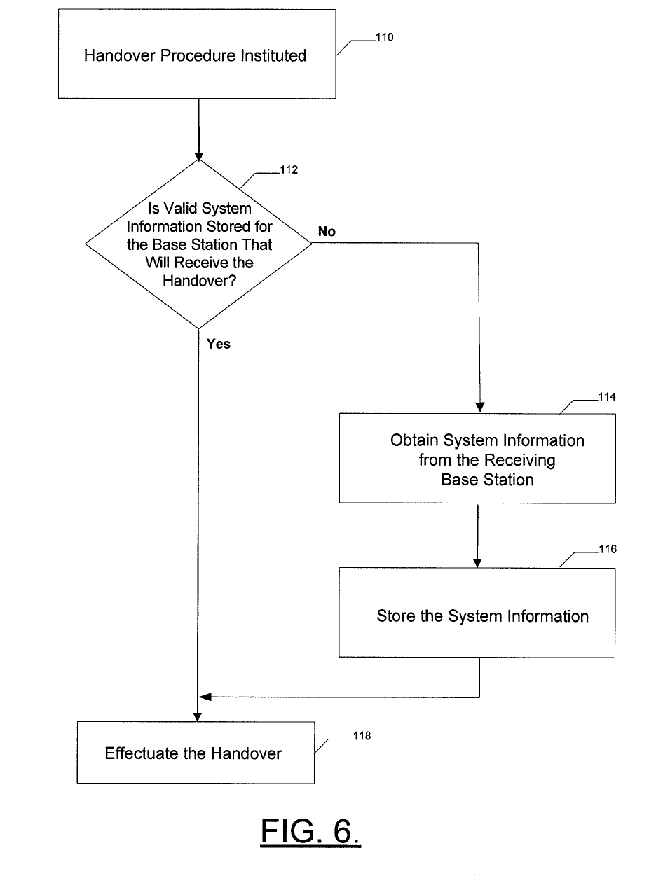

FIGS. 5 and 6 are flowcharts of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for obtaining and storing system information from neighboring base stations 44 as illustrated in FIG. 5 includes the initial receipt by a mobile terminal 10 of a broadcast message from a neighboring base station 44, as shown in operation 100. The mobile terminal then determines the identity of the neighboring base station, as shown in operation 102. Based upon the identity of the neighboring base station, the mobile terminal determines if system information is stored for the neighboring base station and, if so, if the stored system information satisfies the predefined validity criteria, as shown in operation 104. If valid system information is already stored by the mobile terminal, the mobile terminal does not again read the system information of the respective base station and, instead, continues monitoring for broadcast messages from other base stations in operation 100. If the mobile terminal determines, however, that system information for the respective base station is not already stored in memory or, even if the system information is already stored in memory, does not satisfy the predefined validity criteria, the mobile terminal reads the system information, such as the SU-1 information, broadcast by the respective base station, as shown in operation 106. The mobile terminal then stores the system information, such as in memory 40, along with an identification of the respective base station, as shown in operation 108. As noted above, according to the SU-1 information, the mobile terminal may apply different mobility procedures. For example, system information relating to a barred cell that is read and stored by the mobile terminal may not need to be reported by the mobile terminal to the network. Also, if a mobile terminal that is roaming identifies a base station based upon the system information that is read and stored that belongs to the home network of the mobile terminal, the mobile terminal may decide to move immediately to its home network by effectuating a handover procedure to the base station that has been identified to belong to its home network.

Additionally, FIG. 6 depicts one embodiment of a method for effectuating a handover of a mobile terminal 10. In this regard, in response to the institution of the handover procedure in operation 110, the mobile terminal determines if system information is stored for the base station to which the mobile terminal is to be handed over and, if so, if the stored system information satisfies the predefined validity criteria, as shown in operation 112. If valid system information is already stored by the mobile terminal, the mobile terminal does not again read the system information of the respective base station and, instead, continues to effectuate the handover in operation 118. If the mobile terminal determines, however, that system information for the base station to which the mobile terminal is to be handed over is not already stored in memory or, even if the system information is already stored in memory, does not satisfy the predefined validity criteria, the mobile terminal reads the system information, such as the SU-1 information, broadcast by the respective base station, as shown in operation 114. The mobile terminal then stores the system information, such as in memory 40, along with an identification of the respective base station as shown in operation 116 prior to effectuating the handover as shown in operation 118. Although one embodiment as illustrated in FIG. 6 reads and stores system information prior to handover, in alternative embodiments handover may be effectuated prior to reading and storing the system information.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. For example, the methods, apparatus and computer program products of embodiments of the present invention may be applied not only to effectuate handovers between intra-frequency neighboring base stations, but also between inter-frequency and inter-RAT (Radio Access Technology) neighboring base stations. In instances in which a mobile terminal 10 moves to another inter-frequency carrier or another inter-RAT system, the mobile terminal may be required to reset its database and again acquire the system information for each neighboring base station 44. Alternatively, the system information stored by the mobile terminal prior to its movement to another inter-frequency carrier or another inter-RAT system may be maintained and the mobile terminal may continue to use the system information following its movement to another inter-frequency carrier or another inter-RAT system, generally subject to a predefined validity criteria as described above. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
obtaining at least some system information from at least one neighboring base station;
storing the system information in association with the base station(s) from which it was obtained; and
participating in a handover or reselection to a respective neighboring base station based at least in part upon the stored system information associated with the respective neighboring base station without verification of the system information.

2. A method according to claim 1, further comprising determining if one or more predefined validity criterion is met with respect to the stored system information and, if not, obtaining at least some information from at least one neighboring base station so as to update the stored system information.

3. A method according to claim 2, wherein the one or more predefined validity criterion comprise one or more of a maximum time elapsed since the stored system information was obtained, a maximum time elapsed since the stored system information was stored, or a maximum number of handovers or reselections.

4. A method according to claim 2, wherein values for the one or more predefined validity criterion are determined based upon one or more of a signal sequence re-use distance, network topology, anticipated mobility of a mobile device, or anticipated usage of the mobile device.

5. A method according to claim 1, wherein storing the system information in association with the base station(s) from which it was obtained comprises storing the system information in association with a reference signal sequence(s) of the base station(s) from which the system information was obtained.

6. A method according to claim 1, wherein the system information indicates one or more of an identity of a public land mobile network, a tracking area code, a cell identity, a cell barring status, scheduling information of one or more scheduling units, mapping information, or availability information.

7. A method according to claim 1, wherein a neighboring base station comprises a base station whose broadcast is detected.

8. A method according to claim 1, further comprising compressing at least some of the stored system information.

9. A computer program product comprising at least one computer-readable storage medium having computer-readable program code portions stored therein, the computer-readable program code portions comprising:
a first executable portion for obtaining at least some system information from at least one neighboring base station;
a second executable portion for storing the system information in association with the base station(s) from which it was obtained; and
a third executable portion for participating in a handover or reselection to a respective neighboring base station based at least in part upon the stored system information associated with the respective neighboring base station without verification of the system information.

10. A computer program product according to claim 9, further comprising:
a fourth executable portion for determining if one or more predefined validity criterion is met with respect to the stored system information and, if not, obtaining at least some information from at least one neighboring base station so as to update the stored system information.

11. A computer program product according to claim 10, wherein the one or more predefined validity criterion comprise one or more of a maximum time elapsed since the stored system information was obtained, a maximum time elapsed since the stored system information was stored, or a maximum number of handovers or reselections.

12. A computer program product according to claim 10, wherein the values for the one or more predefined validity criterion are determined based upon one or more of a signal sequence re-use distance, network topology, anticipated mobility of a mobile device, or anticipated usage of the mobile device.

13. A computer program product according to claim 9, wherein the second executable instruction includes instructions for storing the system information in association with a reference signal sequence(s) of the base station(s) from which the system information was obtained.

14. A computer program product according to claim 9, wherein the system information indicates one or more of an identity of a public land mobile network, a tracking area code, a cell identity, a cell barring status, scheduling information of one or more scheduling units, mapping information, or availability information.

15. A computer program product according to claim 9, wherein a neighboring base station comprises a base station whose broadcast is detected.

16. A computer program product according to claim 9, wherein the third executable portion includes instructions for compressing at least some of the system information.

17. An apparatus comprising a processor configured to:
obtain at least some information from at least one neighboring base station;
store the system information in association with the base station(s) from which it was obtained; and
participate in a handover or reselection to a respective neighboring base station based at least in part upon the stored system information associated with the respective neighboring base station without verification of the system information.

18. An apparatus according to claim 17, wherein the processor is further configured to:
determine if one or more predefined validity criterion is met with respect to the stored system information and, if not, obtain at least some information from at least one neighboring base station so as to update the stored system information.

19. An apparatus according to claim 18, wherein the one or more predefined validity criterion comprise one or more of a maximum time elapsed since the stored system information was obtained, a maximum time elapsed since the stored system information was stored, or a maximum number of handovers or reselections.

20. An apparatus according to claim 18, wherein values for the one or more predefined validity criterion are determined based upon one or more of a signal sequence re-use distance, network topology, anticipated mobility of a mobile device, or anticipated usage of the mobile device.

21. An apparatus according to claim 17, wherein the processor is further configured to store the system information in association with a reference signal sequence(s) of the base station(s) from which the system information was obtained.

22. An apparatus according to claim 17, wherein system information indicates one or more of an identity of a public land mobile network, a tracking area code, a cell identity, a cell barring status, scheduling information of one or more scheduling units, mapping information, or availability information.

23. An apparatus according to claim 17, wherein a neighboring base station comprises a base station whose broadcast is detected.

24. An apparatus according to claim 23 wherein the processor is further configured to compress at least some of the stored system information.

25. An apparatus comprising:
means for obtaining at least some system information from at least one neighboring base station;
means for storing the system information in association with the base station(s) from which it was obtained; and
means for participating in a handover or reselection to a respective neighboring base station based at least in part upon the stored system information associated with the respective neighboring base station without verification of the system information.
